(19) United States
(12) Patent Application Publication
(10) Pub. No.: US 2023/0040702 A1
(43) Pub. Date: Feb. 9, 2023

(54) FLUID SUPPLY APPARATUS FOR CENTRIFUGE

(71) Applicant: CYTODX INC., Daejeon (KR)

(72) Inventors: Joseph SUNOO, Seongnam-si (KR); Min Pyo HONG, Suwon-si (KR); Sin Uk RYU, Seoul (KR)

(73) Assignee: CYTODX INC., Daejeon (KR)

(21) Appl. No.: 17/485,865

(22) Filed: Sep. 27, 2021

(30) Foreign Application Priority Data
Aug. 9, 2021 (KR) 10-2021-0104480

(51) Int. Cl. B04B 11/04

(52) U.S. Cl. CPC B04B 11/04

(57) ABSTRACT

A fluid supply apparatus for a centrifuge, which supplies a fluid to a centrifuge chamber of the centrifuge is provided. The fluid supply apparatus includes a nozzle unit configured to supply the fluid, a nozzle moving unit movable between an inside or an outside of the centrifuge, a nozzle receiving unit to supply the fluid to the centrifuge chamber by seating the nozzle moving unit, and a fixing unit coupled to the nozzle moving unit such that the nozzle moving unit is movable, and fixed to the centrifuge.

CROSS-REFERENCE TO RELATED APPLICATION(S)

This application is based on and claims priority under 35 U.S.C. § 119 to Korean Patent Application No. 10-2021-0104480, filed on Aug. 9, 2021, in the Korean Intellectual Property Office, the disclosure of which is incorporated by reference herein its entirety.

### BACKGROUND

### 1. Field

The disclosure relates to a fluid supply apparatus for a centrifuge. More particularly, the disclosure relates to a fluid supply apparatus for a centrifuge, capable of automatically supplying a fluid into a chamber in the centrifuge.

### 2. Description of Related Art

A centrifuge may be used to extract peripheral blood mononuclear cells (PBMCs) or circulating tumor cell (CTCs) from blood. However, a remarkably smaller number of PBMCs or the CTCs are present in the blood, and, if the PBMCs or the CTCs are not separated within 24 hours after the blood of a person is collected, the cells may be destroyed. Accordingly, the PBMCs or the CTCs should be rapidly and exactly extracted.

However, according to the related art, a reagent, a magnet, and a centrifuge are used to separate the CTC, but a person is personally involved in a separation process. Accordingly, a result may be varied depending on the ability of the person involved in a centrifugal separation process, so there may be a limitation in repeatedly and precisely carrying out the separation process.

For example, according to the related art, after injecting a suspended density gradient material and blood into a container, such as a conical tube, and centrifuging the result, an extraction tool, such as a pipette, is inserted till a position, at which the separated PBMCs are position, to extract the PBMCs. However, as the suspended density gradient material and the blood are mixed before the centrifugal separation, PBMCs or CTCs may be easily lost. In addition, because a person has a limitation in exactly inserting the extraction tool till the position, at which the PBMCs are position, through a manual work, it is difficult to quantatively extract the PBMCs or the CTCs.

In addition, according to the related art, to extract a target cell having higher purity, a secondary centrifugal separation process is performed by extracting only a specific material after a primary centrifugal separation process. However, a worker has a limitation in exactly and rapidly transferring a material, which is primarily centrifugal-separated, to another centrifuge or a chamber for centrifugal separation to perform the secondary centrifugal separation process. Similarly, a worker may have a limitation in precisely and rapidly carrying out the process of supplying a fluid, such as an additional density gradient material, from the outside, for the secondary centrifugal separation process after the primary centrifugal separation process.

### SUMMARY

Aspects of the disclosure are to address at least the above-mentioned problems and/or disadvantages and to provide at least the advantages described below. Accordingly, an aspect of the disclosure is to realize full automation when supplying a fluid during a centrifugal separation process using a centrifuge, thereby remarkably improving the repeatability and the precision of the centrifugal separation process.

In accordance with an aspect of the disclosure, a fluid supply apparatus for the centrifuge”, which supplies a fluid into a centrifuge chamber of the centrifuge, includes a nozzle unit to supply the fluid, a nozzle moving unit movable between an inside of and an outside of the centrifuge, a nozzle receiving unit to seat the nozzle moving unit in the nozzle receiving unit to supply the fluid into the centrifugal chamber, and a fixing unit coupled to the nozzle moving unit such that the nozzle moving unit is movable while being fixed to the centrifuge.

According to an embodiment of the disclosure, in the fluid supply apparatus for the centrifuge, according to an embodiment of the disclosure, the nozzle moving unit may include a seating unit having the central portion, through which the nozzle unit passes in an axial direction of the nozzle moving unit, and making contact with the nozzle receiving unit when the nozzle moving unit is seated in the nozzle receiving unit, a sliding unit coupled to the nozzle unit and sliding in the axial direction on the seating unit to move the nozzle unit, and an axial angle adjusting unit coupled to the sliding unit to adjust an axial angle, which is formed in the axial direction, of the nozzle moving unit, when the nozzle moving unit is introduced into the nozzle receiving unit.

According to an embodiment of the disclosure, in the fluid supply apparatus for the centrifuge, the axial angle adjusting unit may include a disk having an annular shape, including a central hole, through which the sliding unit passes, and a plurality of through holes, and fixedly coupled to the fixing unit, a plurality of first shafts, each shaft having one end fixedly coupled to the sliding unit and an opposite end coupled to the thorough hole to slide or to be inclined, and an axial angle adjusting elastic unit to apply elasticity to the disk and the sliding unit while surrounding the first shaft.

According to an embodiment of the disclosure, in the fluid supply apparatus for the centrifuge, the sliding unit may include a first sidewall having an inner surface formed to slide along an outer surface of the seating unit, a first inner space formed inside the first sidewall, in which the seating unit is disposed in the first inner space in one direction of the axial direction, a first upper wall formed at an opposite end of the first sidewall in the axial direction, the nozzle unit passing through the center of the first upper wall and fixedly coupled to the center of the first upper wall, and a flange having an annular shape and fixedly coupled to the plurality of first shafts while extending in a radiation direction from the first sidewall.

According to an embodiment of the disclosure, in the fluid supply apparatus for the centrifuge, the seating unit may include a second sidewall formed to allow the first sidewall to slide, a seating surface extending in one direction of the axial direction from the second sidewall to make contact with the nozzle receiving unit, and a second inner space to allow the nozzle unit to pass through the seating unit.

According to an embodiment of the disclosure, in the fluid supply apparatus for the centrifuge, the nozzle receiving unit may include a receiving surface formed in the shape corresponding to the shape of the seating surface to make contact with the seating surface, an injection hole into which the nozzle unit of the nozzle moving unit, which is seated on the receiving surface, is able to be introduced, and a first valve unit to be open or closed to supply the fluid from the nozzle unit introduced into an injection hole or to cut off the supply of the fluid from the nozzle unit introduced into the injection hole.

According to an embodiment of the disclosure, in the fluid supply apparatus for the centrifuge, the first valve unit may include a ball to open or close the injection hole, and a valve elastic structure to apply force to the ball toward the injection hole. The sliding unit moves in one direction of the axial direction such that the nozzle unit pushes the ball in the one direction of the axial direction, thereby enabling the first valve unit to be open.

According to an embodiment of the disclosure, in the fluid supply apparatus for the centrifuge, the fixing unit may include a base fixed to a vessel of the centrifuge, a support structure fixed to the base while extending upward from the base, a second shaft interposed between an upper end of the support structure and the base, and an intermediate structure sliding on the second shaft to move the nozzle moving unit.

According to an embodiment of the disclosure, in the fluid supply apparatus for the centrifuge, the intermediate structure may include a first frame slidably coupled to the second shaft to move the nozzle moving unit in a first direction, a first tube coupled to the nozzle unit to supply the fluid to the nozzle unit from the outside, a second frame coupled to the disk and open in one side of the second frame such that the first tube passes through the one side of the second frame, and an axis aligning unit coupled between the first frame and the second frame to move the nozzle moving unit in a second direction perpendicular to the first direction, such that the nozzle moving unit is aligned in line with an axis of the nozzle receiving unit.

According to an embodiment of the disclosure, in the fluid supply apparatus for the centrifuge, the axis aligning unit may include a third frame coupled to the first frame and having a sliding groove and a fourth frame coupled to the second frame to slide in the second direction in the sliding groove.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating the use of a fluid supply apparatus for a centrifuge, according to the disclosure;

FIG. 2 is a side view illustrating the use of a fluid supply apparatus for centrifuge, according to the disclosure;

FIGS. 3A and 3B are views illustrating a nozzle moving unit, according to the disclosure;

FIG. 4 is a view illustrating a loading procedure of a fluid supply apparatus, according to the disclosure;

FIG. 5 is a view illustrating a procedure of adjusting an axial angle of a nozzle moving unit in a fluid supply apparatus, according to the disclosure;

FIG. 6 is a view illustrating the coupling between a nozzle receiving unit and a centrifuge, according to the disclosure;

FIG. 7 is a view illustrating a nozzle moving unit and a fixing unit, according to the disclosure; and

FIGS. 8A and 8B are enlarged view of a portion of a fixing unit, according to the disclosure.

### DETAILED DESCRIPTION

Hereinafter, various embodiments of the disclosure will described with reference to accompanying drawings. However, those of ordinary skill in the art should understand that the disclosure is not limited to a specific embodiment, and modifications, equivalents, and/or alternatives on the various embodiments described herein can be variously made without departing from the scope and spirit of the disclosure. With regard to description of drawings, similar components may be assigned with similar reference numerals.

In the disclosure, it will be further understood that the terms “have”, “can have,” “includes” and/or “can include”, when used herein, specify the presence of stated features (for example, components such as a numeric value, a function, an operation, or a part), but do not preclude the presence or addition of one or more other features.

In the disclosure, the expressions “A or B”, “at least one of A and/or B”, “one or more of A and/or B” may include all possible combinations of one or more of the associated listed items. For example, “A or B”, “at least one of A and B”, or “at least one of A or B” includes all (1) at least one A, (2) at least one B, or (3) at least one “A” and at least one “B”.

The wording “˜configured to” used in the disclosure can be interchangeably used with, for example, “suitable for”, “having the capacity to”, “designed to”, “adapted to”, “made to”, or “capable of”. The wording “˜configured to” does not refer to essentially “specifically designed to”.

The terms in the disclosure are used only for specific embodiments, and the scope of another embodiment is not limited thereto. The terms of a singular form may include plural forms unless otherwise specified. In addition, unless otherwise defined, all terms used in the disclosure, including technical or scientific terms, have the same meanings as those generally understood by those skilled in the art to which the disclosure pertains. Such terms, which are used herein, as those defined in a generally used dictionary are to be interpreted as having meanings equal to the contextual meanings in the relevant field of art, and are not to be interpreted as having ideal or excessively formal meanings unless clearly defined as having such in the disclosure. Even if the terms are defined in the disclosure, the terms should not be interpreted as excluding embodiments of the disclosure if necessary.

The embodiment disclosed herein should be suggested for the convenience of explanation, and should not limit the scope of the disclosure. Accordingly, the technical scope of the disclosure should be interpreted as including all modifications or various changes based on the technical spirit of the disclosure.

Hereinafter, the embodiment of the disclosure will be described in detail. Before the description of the embodiment, terms and words used in the present specification and the claims should not be interpreted as commonly-used dictionary meanings, but should be interpreted as to be relevant to the technical scope of the disclosure based on the fact that the disclosure may properly define the concept of the terms to explain the disclosure in best ways.

Therefore, features of the embodiment described in the disclosure are only part of the most exemplary embodiments of the disclosure, and do not represent all technical scopes of the embodiments, so it should be understood that various equivalents and modifications could exist at the time of filing this application.

Throughout the whole specification, when a certain part “includes” a certain component, the certain part does not exclude other components, but may further include other components unless there is a specific opposite description.

In this disclosure, objects, specific advantages, and novel features of the disclosure will become apparent from the following description and embodiments which will be described in detail with reference to the accompanying drawings. In adding the reference numerals to the components of each drawing, it should be noted that the same component is assigned with the same numeral number even when they are displayed on other drawings. In addition, the terms “one surface”, an “opposite surface”, “first˜”, and “second˜” are used to distinguish one component from another component, and a component is not limited to the terms. In addition, in the following description of the disclosure, a detailed description of well-known art or functions will be ruled out in order not to unnecessarily obscure the gist of the disclosure.

Hereinafter, the detailed description of the disclosure will be described in detail with reference to accompanying drawings, and the same reference numeral indicates the same member.

Hereinafter, an apparatus 1 (fluid supply apparatus 1) for supplying a fluid for a centrifuge will be described with reference to accompanying drawings, according to an embodiment of the disclosure.

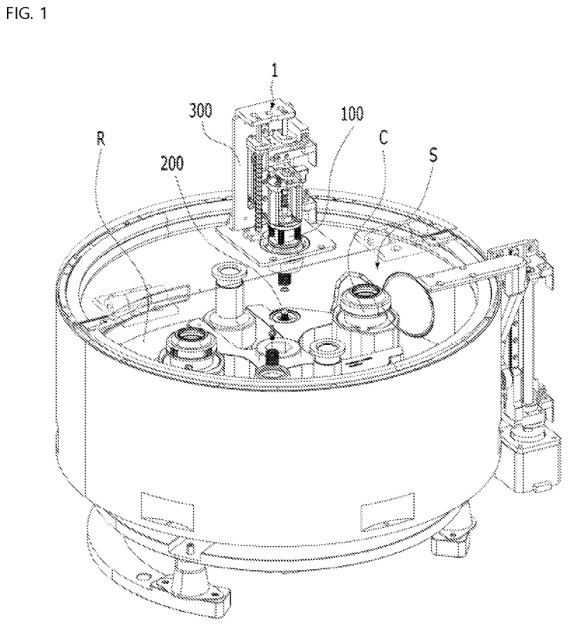

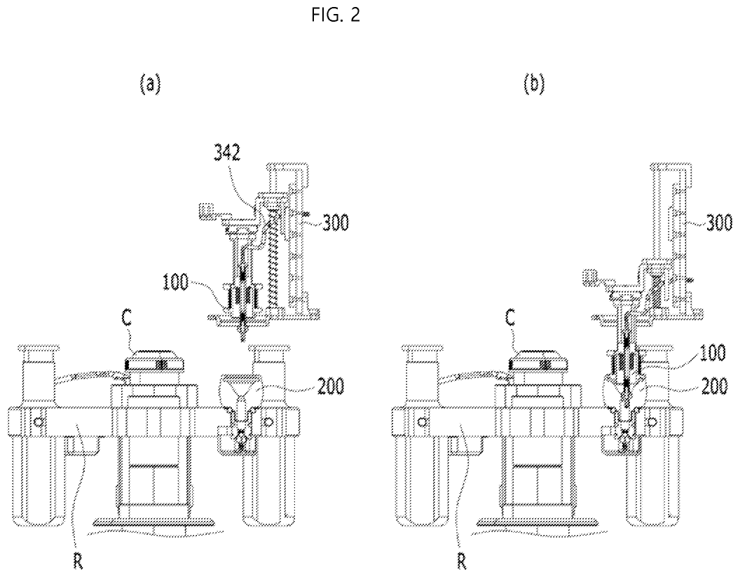

FIGS. 1 and 2 are views illustrating the fluid supply apparatus 1 for the centrifuge, according to an embodiment of the disclosure.

Referring to FIGS. 1 and 2, the centrifuge “S” basically includes a rotor “R” and a chamber “C”. The rotor “R” receives driving force from a motor to rotate the chamber “C”. Blood and a reagent to be centrifuged may be stored in the chamber “C”, and a material in the chamber “C” is centrifuged by the rotation of the rotor “R”. The chamber “C” may include a first chamber and a second chamber. The first chamber and the second chamber may be provided at a peripheral region of the rotor “R”. The first chamber and the second chamber may perform mutually different functions. For example, a primary centrifugal separation process is performed in the first chamber while a secondary centrifugal separation process is performed in the second chamber. Therefore, according to the disclosure, two centrifugal separation processes, which are mutually different from each other, may be performed in one centrifuge “S”. As the centrifugal separation process is divided into the primary centrifugal separation process and the secondary centrifugal separation process, a material resulting from the primary centrifugal separation process is moved into the second chamber to experience the secondary centrifugal separation process. In this case, as the weights of the first chamber and the second chamber are changed, the centers of the gravity of the rotor “R” and the chamber “C” may not be matched with the centers of rotation of the rotor “R” and the chamber “C”. Accordingly, vibration may be generated due to the rotation of the rotor “R” to interrupt the centrifugal separation process. Accordingly, to solve the above problem, a reagent, such as a density gradient material, has to be injected into the first chamber or the second chamber during the secondary centrifugal separation process, such that the whole centers of gravity of the rotor “R” and the chamber “C” are positioned along a rotational axis. In this procedure, the fluid supply apparatus 1 according to the disclosure may be used, but the function of the fluid supply apparatus 1 is not limited thereto.

According to the disclosure, the fluid supply apparatus 1 for the centrifuge “S”, which supplies a fluid into the chamber “C” of the centrifuge “S”, includes a nozzle unit 110 to supply the fluid, a nozzle moving unit 100 movable between an inside of and an outside of the centrifuge “S”, a nozzle receiving unit 200 to seat the nozzle moving unit 100 in the nozzle receiving unit 200 to supply the fluid into the chamber “C”, and a fixing unit 300 coupled to the nozzle moving unit 100 such that the nozzle moving unit 100 is movable while being fixed to the centrifuge “S”.

According to an embodiment of the disclosure, the fluid supply apparatus 1 for the centrifuge “S” includes the nozzle moving unit 100, the nozzle receiving unit 200, and the fixing unit 300. As illustrated in FIG. 1, according to the disclosure, the fluid supply apparatus 1 is disposed in the centrifuge “S”. In other words, according to the disclosure, the fluid supply apparatus 1 is disposed in the centrifuge “S” to automatically supply a fluid into the centrifuge “S”. According to the disclosure, the fluid supplied by the fluid supply apparatus 1 is supplied from the outside of the centrifuge “S”. Accordingly, the fluid supply apparatus 1 has the structure to move a fluid (external fluid), which is positioned outside the centrifuge “S, into the centrifuge “S”.

According to the disclosure, the nozzle moving unit 100 includes the nozzle unit 110. Accordingly, the external fluid is supplied into the centrifuge “S” through the nozzle unit 110 of the nozzle moving unit 100. The nozzle moving unit 100 is designed to be movable between the inside and the outside of the centrifuge “S”. Accordingly, when the rotor “R” rotates to perform the centrifugal separation process, the nozzle moving unit 100 is disposed outside the centrifuge “S”. When the rotor “R” is not rotated, for example, when the fluid needs to be supplied into the chamber “C” between the primary centrifugal separation process and the secondary centrifugal separation process, the nozzle moving unit 100 is introduced into the centrifuge “S” to supply the fluid into the chamber “C” through the nozzle receiving unit 200.

When the nozzle moving unit 100 is introduced into the centrifuge “S” to supply the fluid, the nozzle receiving unit 200 seats the nozzle moving unit 100. As illustrated in FIG. 2, the nozzle receiving unit 200 is disposed in the rotor “R” to supply the fluid, which is received from the nozzle unit 110, into the chamber “C”.

The fixing unit 300 fixes the nozzle moving unit 100 to the centrifuge “S”. In other words, as illustrated in FIG. 1, the fixing unit 300 is formed on a cover of the centrifuge “S”. In addition, the nozzle moving unit 100 is coupled to the fixing unit 300 in such a manner that the nozzle moving unit 100 is movable. Accordingly, the fixing unit 300 may allow the nozzle moving unit 100 to reciprocate between the inside and the outside of the centrifuge “S”.

Referring to reference sign (a) of FIG. 2, the nozzle moving unit 100 is disposed outside the centrifuge “S”, and separated from the nozzle receiving unit 200. This state is referred to as an “unloading state”, and the fluid supply apparatus 1 is in the unloading state when the rotor “R” rotates to perform the centrifugal separation process. Referring to reference sign (b) of FIG. 2, the nozzle moving unit 100 is introduced into the centrifuge “S” and coupled to the nozzle receiving unit 200. This state is referred to as a “loading state” and the fluid supply apparatus 1 is disposed in the loading state when the fluid needs to be supplied into the chamber “C”.

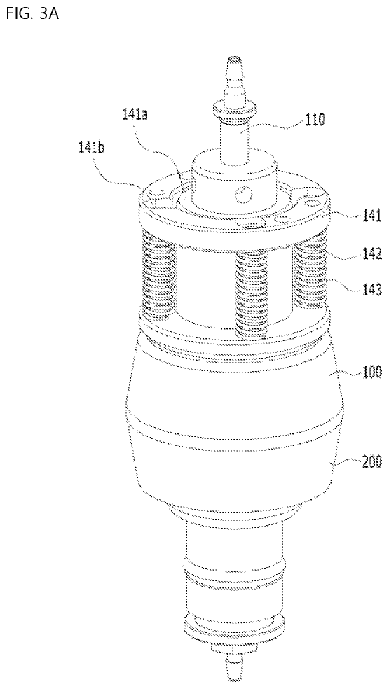

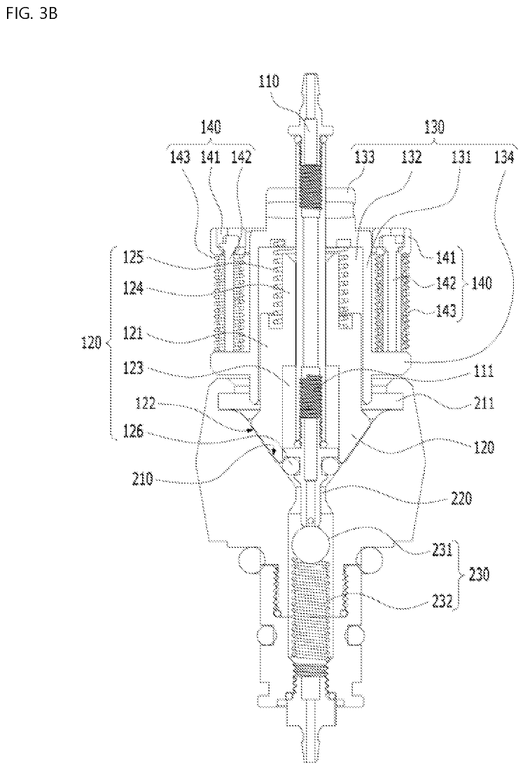

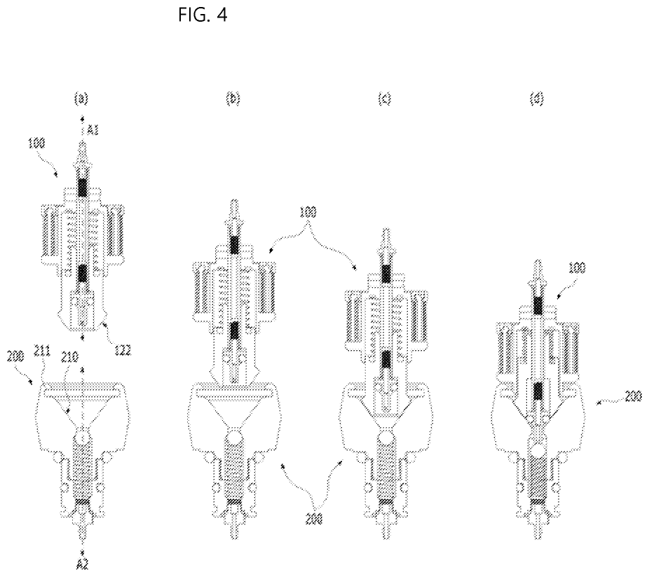

FIGS. 3A and 3B illustrate the nozzle moving unit 100 and the nozzle receiving unit 200, according to an embodiment of the disclosure, and FIG. 4 illustrates the arrangement of the nozzle moving unit 100 and the nozzle receiving unit 200 when the unloading state is changed to the load state.

In the fluid supply apparatus 1 for the centrifuge “S”, according to an embodiment of the disclosure, the nozzle moving unit 100 may include a seating unit 120 having the central portion, through which the nozzle unit 110 passes in an axial direction “A1” of the nozzle moving unit 100, and making contact with the nozzle receiving unit 200 when the nozzle moving unit 100 is seated in the nozzle receiving unit 200, a sliding unit 130 coupled to the nozzle unit 110 and sliding in the axial direction “A1” on the seating unit 120 to move the nozzle unit 110, and an axial angle adjusting unit 140 coupled to the sliding unit 130 to adjust an axial angle, which is formed in the axial direction “A1”, of the nozzle moving unit 100, when the nozzle moving unit 100 is introduced into the nozzle receiving unit 200.

According to an embodiment of the disclosure, the nozzle moving unit 100 of the fluid supply apparatus 1 may include the seating unit 120, the sliding unit 130, and the axial angle adjusting unit 140.

The seating unit 120 is a component to make contact with the nozzle receiving unit 200. FIGS. 3A and 3B illustrate the nozzle moving unit 100 and the nozzle receiving unit 200 in the loading state, which are similar to reference sign (b) of FIG. 2. Referring to FIG. 3B, the seating unit 120 makes contact with the nozzle receiving unit 200, in the loading state. The nozzle unit 110 is disposed at the central portion of the seating unit 120 to pass through the central portion of the seating unit 120 in the axial direction “A1” of the nozzle moving unit 100.

The sliding unit 130 is formed to slide on the seating unit 120 in the axial direction “A1”. The sliding unit 130 is coupled to the nozzle unit 110 such that an end of the nozzle unit 110 is introduced into the nozzle receiving unit 200 when the sliding unit 130 moves forward in one direction of the axial direction “A1” in the loading state.

FIG. 4 illustrates the change in arrangement of the nozzle moving unit 100 and the nozzle receiving unit 200, according to an embodiment of the disclosure. Reference sign (a) of FIG. 4 illustrates the unloading state in which the nozzle moving unit 100 is positioned outside the centrifuge “S”. Reference sign (b) of FIG. 4 illustrates the procedure that the nozzle moving unit 100 in the unloading state is introduced into the centrifuge “S” to approach the nozzle receiving unit 200. Reference sign (c) of FIG. 4 illustrates the loading state in which the seating unit 120 is seated in the nozzle receiving unit 200 and the nozzle unit 110 is still disposed inside the nozzle moving unit 100. Reference sign (d) of FIG. 4 illustrates that the sliding unit 130 moves forward in one direction of the axial direction “A1” to introduce the nozzle unit 110 into the nozzle receiving unit 200, such that the fluid is supplied to the nozzle receiving unit 200 through the nozzle unit 110. In this case, the fluid is supplied to the nozzle receiving unit 200 from the nozzle unit 110.

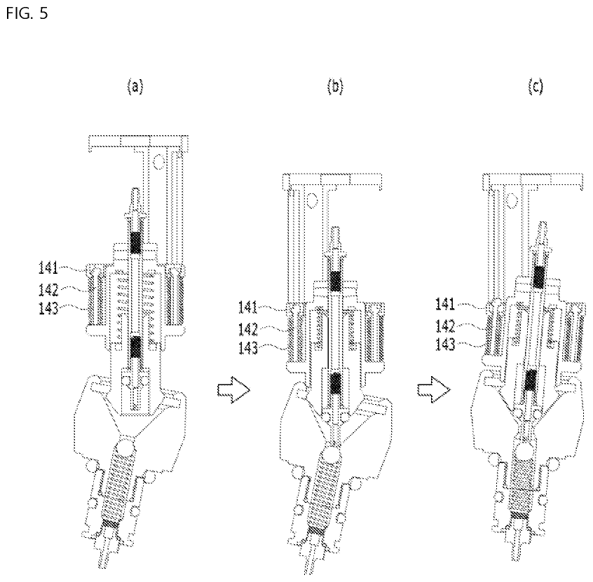

The axial angle adjusting unit 140 is coupled to the sliding unit 130 to adjust an axial angle, which is formed in the axial direction “A1”, of the nozzle moving unit 100. Referring to FIG. 5, as the rotor “R” rotates, an axial direction “A2” of the nozzle receiving unit 200 may be changed. Accordingly, when the nozzle moving unit 100 approaches the nozzle receiving unit 200 to load the nozzle unit 110, the axial direction “A1” of the nozzle moving unit 100 may not be matched with the axial direction “A2” of the nozzle receiving unit 200. In this case, the seating unit 120 of the nozzle moving unit 100 is not securely seated in the nozzle receiving unit 200. Accordingly, the axial angle adjusting unit 140 adjusts the axial angle of the nozzle moving unit 100 such that the axial direction “A1” of the nozzle moving unit 100 is matched with the axial direction “A2” of the nozzle receiving unit 200.

FIG. 5 illustrates the use state of the in the fluid supply apparatus, in which the axial angle of the nozzle moving unit 100 is adjusted, according to an embodiment of the disclosure.

According to an embodiment of the disclosure, in the fluid supply apparatus 1 for the centrifuge “S”, the axial angle adjusting unit 140 may include a disk 141, which has an annular shape, includes a central hole 141a, through which the sliding unit 130 passes, and a plurality of through holes 141b, and is fixedly coupled to the fixing unit 300, a plurality of first shafts 142, each first shaft having one end fixedly coupled to the sliding unit 130 and an opposite end coupled to the thorough hole 141b to slide or to be inclined, and an axial angle adjusting elastic unit 143 to apply elasticity to the disk 141 and the sliding unit 130 while surrounding the first shaft 142.

According to an embodiment of the disclosure, the axial angle adjusting unit 140 of the fluid supply apparatus 1 may include the disk 141 having the annular shape, the plurality of first shafts 142, and the axial angle adjusting elastic unit 143.

According to the disclosure, the disk 141 may be formed in the annular shape. The central hole 141a is formed in the center of the disk 141, and the plurality of through holes 141b may be formed in an annular outer portion of the disk 141. The disk 141 is fixedly coupled to the fixing unit 300. Accordingly, the disk 141 is a component to connect the nozzle moving unit 100 with the fixing unit 300.

The plurality of first shafts 142 are engaged with the plurality of through holes 141b formed in the disk 141. The first shaft 142 may be coupled to the through hole 141b with a gap. Accordingly, the first shaft 142 not only slides through the through hole 141b, but also is inclined by utilizing the gap. In other words, the axial direction “A1” of the nozzle moving unit 100 is adjusted through an inclination movement of the first shaft 142 connected with the disk 151. Accordingly, the axial angle, which is formed in the axial direction “A1”, of the nozzle moving unit 100 coupled to the fixing unit 300 may be adjusted.

The axial angle adjusting elastic unit 143 surrounds the first shaft 142 while providing elasticity such that the disk 141 and the sliding unit 130 are pushed each other. For example, referring to FIG. 3A, the first shaft 142 and the axial angle adjusting elastic unit 143 are arranged to surround the disk 141 having the annual shape. In this case, some, which are disposed at one side that receives stronger force, of the axial angle adjusting elastic units 143 are greatly contracted, and a remaining axial angle adjusting elastic units 143 are less contracted. Accordingly, the first shaft 142 at the side of the axial angle adjusting elastic unit 143 is moved to the greater extent, when compared to the first shafts 142 at another side of the axial angle adjusting elastic unit 143. Accordingly, the axial direction “A1” of the nozzle moving unit 100 is inclined in the direction in which the axial angle adjusting elastic unit 143 contracted to the greater extent is disposed.

Hereinafter, the operating manner of the axial angle adjusting unit 140 will be described in detail with reference to FIG. 5. Reference sign (a) of FIG. 5 illustrates that the nozzle moving unit 100 approaches the nozzle receiving unit 200 in the unloading state. In this case, the axial direction “A2” of the nozzle receiving unit 200 is titled. Accordingly, the axis of the nozzle receiving unit 200 is not aligned in line with the axial direction “A1” of the nozzle moving unit 100. In this situation, an axial angle, which is formed in the axial direction “A1”, of the nozzle moving unit 100 has to be adjusted by the axial angle adjusting unit 140. As illustrated in reference sign (b) of FIG. 5, a left side of the seating unit 120 makes contact with the nozzle receiving unit 200, and a right side of the seating unit 120 does not make contact with the nozzle receiving unit 200. In this case, the fixing unit 300 consecutively applies force to the nozzle moving unit 100 such that the nozzle moving unit 100 moves down. Accordingly, pressure is applied to the left side of the nozzle moving unit 100 and not applied to the right side of the nozzle moving unit 100. Therefore, as illustrated in reference sign (c) of FIG. 5, the axial angle adjusting elastic unit 143, which is at the left side, is more compressed, such that the first shaft 142 moves upward. Accordingly, the axial angle of the nozzle moving unit 100 is inclined leftward to be aligned in line with the axial direction “A2” of the nozzle receiving unit 200. Therefore, as illustrated in reference sign (c) of FIG. 5, the nozzle moving unit 100 and the nozzle receiving unit 200 may be engaged with each other to make the loading state.

According to an embodiment of the disclosure, in the fluid supply apparatus 1 for the centrifuge “S”, the sliding unit 130 may include a first sidewall 131 having an inner surface formed to slide along an outer surface of the seating unit 120, a first inner space 132 formed inside the first sidewall 1131 such that the seating unit 120 is disposed in the first inner space 132 in one direction of the axial direction “A1”, a first upper wall 133 formed at an opposite end of the first sidewall 131 in the axial direction “A1”, the nozzle unit 110 passing through the center of the first upper wall 133 and fixedly coupled to the center of the first upper wall 133, and a flange 134 having an annular shape and fixedly coupled to the plurality of first shafts 142 while extending in a radiation direction from the first sidewall 131.

According to an embodiment of the disclosure, the sliding unit 130 of the fluid supply apparatus 1 may include the first sidewall 131, the first inner space 132, the first upper wall 133, and the flange 134.

The first sidewall 131 forms a main body structure of the sliding unit 130. The first sidewall 131 may be formed in a cylindrical shape. The inner surface of the first sidewall 131 makes contact with the outer surface of the seating unit 120 while sliding. Accordingly, as illustrated in reference signs (c) and (d) of FIG. 4, when the nozzle unit 110 is introduced into the nozzle receiving unit 200 after the seating unit 120 makes contact with the nozzle receiving unit 200, the inner surface of the sliding unit 130 slides along the outer surface of the seating unit 120.

The first inner space 132 is a space formed inside the first sidewall 131, and the seating unit 120 is disposed in the first inner space 132 to be movable in the axial direction “A1” of the nozzle moving unit 100. The first inner space 132 may be referred to a cylindrical inner space of the first sidewall 141.

The first upper wall 133 is formed at an opposite end of the first sidewall 131 in the axial direction “A1” to block an opposite end of the first inner space 132 in the axial direction “A1”. Referring to FIG. 3B, the nozzle unit 110 passes through the center of the first upper wall 133, and the first upper wall 133 and the nozzle unit 110 are fixedly coupled to each other. Therefore, as the first upper wall 133 is coupled to the nozzle unit 110, the nozzle unit 110 may be moved, as the sliding unit 130 moves in the axial direction “A1”.

The flange 134 is a component extending in the radiation direction from the first sidewall 131 and having the annular shape. As illustrated in reference sign (c) of FIG. 4, the flange 134 is fixedly coupled to the first shaft 142. Accordingly, the axial angle adjusting elastic unit 143, which surrounds the first shaft 142, may be interposed between the flange 134 and the disk 141 having the annular shape to apply elasticity to the disk 141. The flange 134 may have the annular shape extending in the radiation direction from the first sidewall 131, such that the plurality of axial angle adjusting elastic units 143 apply work in the axial direction “A1”.

According to an embodiment of the disclosure, in the fluid supply apparatus 1 for the centrifuge “S”, the seating unit 120 may include a second sidewall 121 formed to allow the first sidewall 131 to slide, a seating surface 122 extending in one direction of the axial direction “A1” from the second sidewall 121 to make contact with the nozzle receiving unit 200, and a second inner space 123 to allow the nozzle unit 110 to pass through the seating unit 120.

According to an embodiment of the disclosure, the seating unit 120 of the fluid supply apparatus 1 may include the second sidewall 121, the seating surface 122, and the second inner space 123.

The second sidewall 121 forms a main body structure of the seating unit 120. The second sidewall 121 and the first sidewall 131 are formed to slide with respect to each other. Accordingly, the second sidewall 121 has a sectional area corresponding to that of the first sidewall 131, and may be formed in a cylindrical shape. As illustrated in reference signs (c) and (d) of FIG. 4, the outer surface of the second sidewall 121 makes contact with the inner surface of the first sidewall 131 while sliding.

The seating surface 122 is a surface to make contact with the nozzle receiving unit 200. The seating surface 122 extends in one direction of the axial direction “A1” from the sidewall 121. As illustrated in FIG. 3B, the sectional view of the seating surface 122 has an oblique line. In other words, the seating surface 122 may have a conical empty space formed in the center of the seating surface 122. As illustrated in FIG. 3B, the oblique angle of the sectional view of the seating surface 122 may correspond to an angle of a receiving surface 210 of the nozzle receiving unit 200 on which the seating surface 122 is seated. Accordingly, even if the seating surface 122 makes contact with the receiving surface 210 while crossing each other, the seating surface 122 may slide along the oblique surface and may be seated such that the axis of the nozzle moving unit 100 is aligned in line with the axis of the nozzle unit 110.

The second inner space 123 is formed to allow the nozzle unit 110 to pass through the seating unit 120. As illustrated in FIG. 3B, the nozzle unit 110 passes through the seating unit 120 in the axial direction “A1”. In this case, a space inside the seating unit 120, through which the nozzle unit 110 passes, is the second inner space 123. The second inner space 123 may be formed in a cylindrical shape. An anti-leak structure 126 may be formed in the second inner space 123 to prevent a fluid from flowing in a direction opposite to a supply direction in the loading state, by surrounding the nozzle unit 110 while making contact with the wall surface of the second inner space 123. The anti-leak structure 126 may be provided in the form that an O-ring shaped structure is filled in a space between the nozzle unit 110 and the receiving surface 210 in the loading state. The second inner space 123 may protect the nozzle unit 110 by surrounding the nozzle unit 110 in the unloading state.

The seating unit 120 may include a second upper wall 124 formed on a surface opposite to the sating surface 122 in the axial direction “A1”. The second upper wall 124 has a hole formed in the center of the second upper wall 124 such that the nozzle unit 110 passes through the hole. The second upper wall 124 has a cylindrical structure extending in the axial direction “A1” in the first inner space 132. A seating unit elastic structure 125 may be provided in the form of surrounding the structure of the second upper wall 124. Accordingly, the seating unit elastic structure 125 is configured to allow the seating surface 122 to press the receiving surface 210, when the seating surface 122 makes contact with the receiving surface 210 to form the loading state. In other words, when the process progresses to the states as in reference sign (c) and reference sign (d) of FIG. 4, the seating unit elastic structure 125 is interposed between the second upper wall 124 and the first upper wall 133 to press the second upper wall 124 such that the seating unit 120 completely makes close contact with the receiving surface 210.

FIG. 3B illustrates a cross-sectional view of the nozzle receiving unit 200, according to the disclosure.

According to an embodiment of the disclosure, in the fluid supply apparatus 1 for the centrifuge “S”, the nozzle receiving unit 200 may include the receiving surface 210 formed in the shape corresponding to the shape of the seating surface 122 to make contact with the seating surface 122, an injection hole 220 into which the nozzle unit 110 of the nozzle moving unit 100, which is seated on the receiving surface 210, is able to be introduced, and a first valve unit 230 to be open or closed to supply the fluid from the nozzle unit 110 introduced into an injection hole 220 or to cut off the supply of the fluid from the nozzle unit 110 introduced into the injection hole 220.

According to an embodiment of the disclosure, the nozzle receiving unit 200 of the fluid supply apparatus 1 may include the receiving surface 210, the injection hole 220, and the first valve unit 230.

The receiving surface 210 is formed in the shape corresponding to the shape of the seating surface 122. Accordingly, it may be recognized from FIG. 3B that the sectional view of the receiving surface 210 is provided in the form of an oblique line, as the sectional view of the seating surface 122 is provided in the form of an oblique line. As the seating surface 122 is seated on the receiving surface 210 while making contact with the receiving surface 210 in the loading state, the nozzle unit 110 may be disposed such that the nozzle unit 110 is introduced into the nozzle receiving unit 200.

The injection hole 220 functions as a passage along which the nozzle unit 110 is introduced into the nozzle receiving unit 200, as the nozzle unit 110 moves in one direction of the axial direction “A1” in the nozzle moving unit 100 in the loading state. As illustrated in FIG. 3B, the injection hole 220 may be provided in the form of a hole formed through the center of the receiving surface 210.

The first valve unit 230 is open or closed to supply the fluid from the nozzle unit 110, which is introduced into the injection hole 220, or to cut off the supply of the fluid from the nozzle unit 110 introduced into the injection hole 220. It may be recognized from FIG. 3B that the first valve unit 230 is disposed in one direction of the axial direction “A2” of the nozzle receiving unit 200 having the injection hole 220.

According to an embodiment of the disclosure, in the fluid supply apparatus 1 for the centrifuge “S”, the first valve unit 230 may include a ball 231 to open or close the injection hole 220, and a valve elastic structure 232 to apply force to the ball 231 toward the injection hole 220. The sliding unit 130 moves in one direction of the axial direction “A1” such that the nozzle unit 110 pushes the ball 231 in the one direction of the axial direction “A1”, thereby enabling the first valve unit 230 to be open.

According to the disclosure, the first valve unit 230 may include the ball 231 and the valve elastic structure 232.

The ball 231 opens or closes the injection hole 220. As illustrated in reference sign (c) of FIG. 4, the ball 231 blocks the injection hole 220 and then is dropped out of the injection hole 220, as the nozzle unit 110 moves forward. Accordingly, the fluid may be introduced from the nozzle unit 110 to the nozzle receiving unit 200.

The valve elastic structure 232 applies force to the ball 231 such that the ball 231 makes close contact with the injection hole 220. The valve elastic structure 232 may include a spring formed in the axial direction “A2” of the nozzle receiving unit 200. Accordingly, when the force is not applied to the ball 231 by the nozzle unit 110, the valve elastic structure 232 makes the ball 231 close contact with the upper portion as illustrated in reference sign (c) of FIG. 4. When the nozzle unit 110 presses the ball 231 to move into the nozzle receiving unit 200, the valve elastic structure 232 is compressed such that the ball 231 is dropped out of the injection hole 220.

The nozzle unit 110 may have a hole formed in a direction perpendicular to the axial direction “A1”. Accordingly, after the nozzle unit 110 pushes the ball 231 out of the injection hole 220, the nozzle unit 110 may supply a fluid into the nozzle receiving unit 200 through the hole.

An anti-remaining fluid leaking groove 211 may be formed in an annular shape on the oblique surface constituting the receiving surface 210. The nozzle receiving unit 200 is positioned at the rotor “R”, so the nozzle receiving unit 200 is rotated together with the rotation of the rotor “R”. In this case, the fluid remaining at a peripheral region of the injection hole 220 may leak out due to the rotation of the rotor “R”. Accordingly, the anti-remaining fluid leaking groove 211 may be designed to prevent the remaining fluid from leaking out due to the centrifugal force and to trap the remaining fluid.

An O-ring may be interposed between the nozzle receiving unit 200 and the rotor “R” to perform a buffer operation.

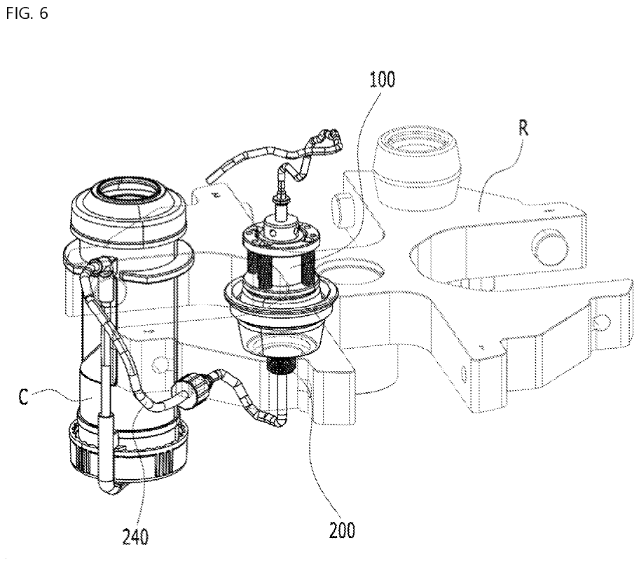

FIG. 6 illustrates a path on which the fluid introduced into the nozzle receiving unit 200 according to the disclosure is introduced into the chamber “C”. In other words, the fluid is supplied into the chamber “C” through a second tube 240 interposed between the nozzle receiving unit 200 and the chamber “C”. The second tube 240 may be designed to supply the fluid into the chamber “C” to a specific height of the chamber “C”. Accordingly, the process of collecting and dividing the specific ingredient, such as the blood plasma or the PBMC, of the blood by using the pipette to treat a reagent for the specific ingredient may be omitted. Therefore, in the state, in which ingredients are divided at layers in the chamber “C”, is maintained, the reagent may be selectively treated with respect to only the specific layer.

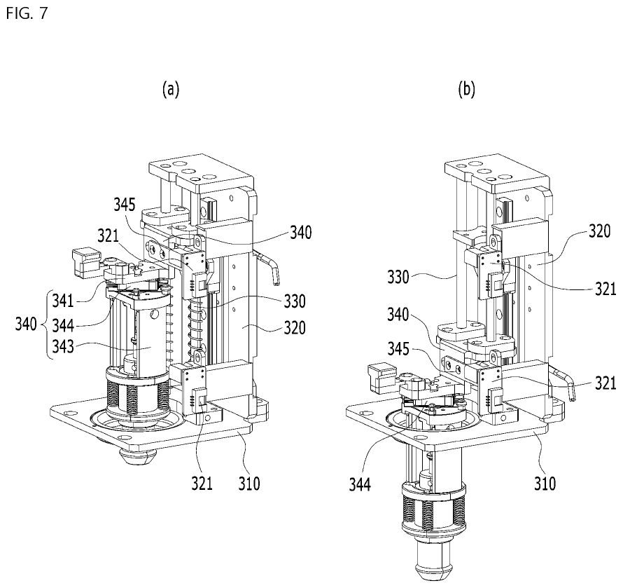

FIG. 7 is a perspective view of the fixing unit 300 and the nozzle moving unit 100, according to an embodiment of the disclosure.

According to an embodiment of the disclosure, in the fluid supply apparatus 1 for the centrifuge “S”, the fixing unit 300 may include a base 310 fixed to a vessel of the centrifuge “S”, a support structure 320 fixed to the base 310 while extending upward from the base 310, a second shaft 330 interposed between an upper end of the support structure 320 and the base 310, and an intermediate structure 340 sliding on the second shaft 330 to move the nozzle moving unit 100.

According to an embodiment of the disclosure, the fixing unit 300 of the fluid supply apparatus 1 for the centrifuge “S” may include the base 310, the support structure 320, the second shaft 330, and the intermediate structure 340.

The base 310 is fixed onto the vessel of the centrifuge “S”. The base 310 may be fixed to a cover of the centrifuge “S”, as illustrated in FIG. 1 of the disclosure.

The support structure 320 may be a structure extending upward from the base 310. The support structure 320 serves as the central main body of the fixing unit 300 and supports another component. The support structure 320 may include a nozzle position sensor 321. As illustrated in FIG. 7, the nozzle position sensor 321 may sense a sensing target 345 attached to the intermediate structure 340. Accordingly, when the sensing target 345 is measured at the upper portion of the support structure 320, the position of the nozzle unit 110 may be in the unloading state. When the sensing target 345 is measured at the lower portion of the support structure 320, the position of the nozzle unit 110 may enter into the loading state.

The second shaft 330 is interposed between an upper end of the support structure 320 and the base 310. It may be recognized from FIG. 7 that the second shaft 330 extends longitudinally in a vertical direction. The second shaft 330 forms a path on which the fixing unit 300 moves the nozzle moving unit 100. A second shaft elastic structure 331 may be provided to surround the second shaft 330. Accordingly, when the intermediate structure 340 moves down, and the force of pressing the intermediate structure 340 is disappeared, the intermediate structure 340 may move upward again due to the repulsive force of the second shaft elastic structure 331.

The intermediate structure 340 slides on the second shaft 330. In addition, the intermediate structure 340 is coupled to the nozzle moving unit 100. Accordingly, the intermediate structure 340 moves along the path of the second shaft 330 while moving the nozzle moving unit 100 in the same direction as the moving direction of the intermediate structure 340. As illustrated in FIG. 7, the second shaft 330 extends in the vertical direction, so the intermediate structure 340 and the nozzle unit 110 may move in the vertical direction.

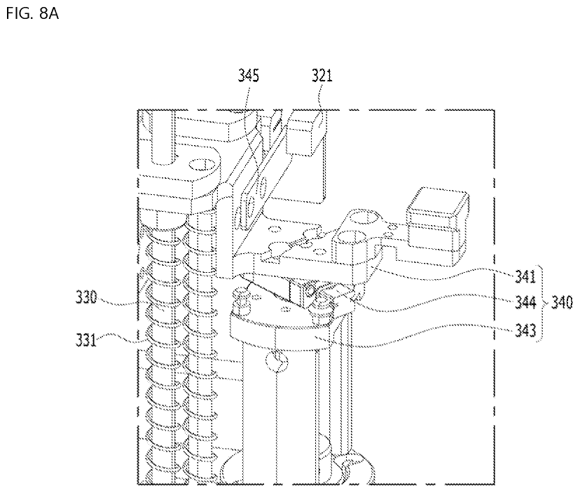

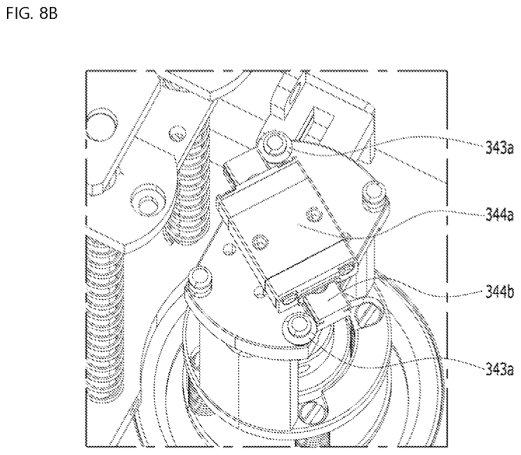

FIGS. 8A and 8B are views illustrating the structure of the intermediate structure 340 in detail, according to an embodiment of the disclosure.

According to an embodiment of the disclosure, in the fluid supply apparatus 1 for the centrifuge “S”, the intermediate structure 340 may include a first frame 341 slidably coupled to the second shaft 330 to move the nozzle moving unit 100 in a first direction, a first tube 342 coupled to the nozzle unit 110 to supply the fluid to the nozzle unit 110 from the outside, a second frame 343 coupled to the disk 141 and open in one side of the second frame 343 such that the first tube 342 passes through the one side of the second frame 343, and an axis aligning unit 344 coupled between the first frame 341 and the second frame 343 to move the nozzle moving unit 100 in a second direction perpendicular to the first direction, such that the nozzle moving unit 100 is aligned in line with an axis of the nozzle receiving unit 200.

According to an embodiment of the disclosure, the intermediate structure 340 may include the first frame 341, the first tube 342, the second frame 343, and the axis aligning unit 344.

The first frame 341 is slidably formed on the second shaft 330 to move the nozzle moving unit 100 in the first direction. As illustrated in FIG. 1, the first direction may be the vertical direction, but is not limited thereto, because a design may be modified in structure. A driving unit to move the first frame 341 may be separately provided, and a push bar may be provided to move the first frame 341 by external force.

The first tube 342 serves as a path to supply the fluid to the nozzle unit 110. A pump and a fluid storage tank may be provided outside, and the fluid may be supplied to the nozzle unit 110 through the first tube 342 by the pump.

The second frame 343 may be coupled to the annual disk 141 to provide driving force to the nozzle unit 110. In other words, as the intermediate structure 340 moves, the disk 141 moves to move the nozzle unit 110. The first tube 342 may pass through one side of the second frame 343 such that the external fluid is supplied to the nozzle unit 110.

The axis aligning unit 344 may align the axis of the nozzle moving unit 100 in line with the axis the nozzle receiving unit 200. As illustrated in FIG. 8A, the axis aligning unit 344 may be coupled between the first frame 341 and the second frame 343 to move the nozzle moving unit 100 in the second direction perpendicular to the first direction. The second direction may be formed in the radial direction of the rotor “R”. In other words, the axis of the nozzle moving unit 100 may be aligned in line with the axis of the nozzle receiving unit 200, because the nozzle receiving unit 200 is moved, as the rotor “R” rotates. In detail, the nozzle receiving unit 200 may be moved in the radiation direction of the rotor “R” due to the rotation of the rotor “R”. Accordingly, the second direction may be set to the radial direction of the rotor “R”. However, the second direction may be modified depending on the design of the centrifuge “S”.

According to an embodiment of the disclosure, in the fluid supply apparatus 1 for the centrifuge “S”, the axis aligning unit 344 may include a third frame 344a coupled to the first frame 341 and having a sliding groove and a fourth frame 344b coupled to the second frame 343 to slide in the second direction in the sliding groove.

According to an embodiment of the disclosure, the axis aligning unit 344 may include the third frame 344a and the fourth frame 344b to move the nozzle moving unit 100 in the second direction. As illustrated in FIG. 8B, the third frame 344a having the sliding groove is formed at an upper portion of the axis aligning unit 344 and coupled to the first frame 341. In addition, the fourth frame 344b is designed to be coupled to the sliding groove to slide in the sliding groove, and to be movable in the second direction. Therefore, as illustrated in reference sign (a) of FIG. 5, as the nozzle moving unit 100 crosses the nozzle receiving unit 200 such that pressure is applied to the nozzle moving unit 100 in one direction, the fourth frame 344b moves in the second direction such that the axis of the nozzle moving unit 100 is aligned in line with the axis of the nozzle receiving unit 200. To make a limit in the sliding range of the fourth frame 344b with respect to the third frame 344a, a bumper 343a may be formed on the second frame 343. Accordingly, an impact caused by the sliding of the fourth frame 344b may be absorbed by the bumper 343a.

In other words, according to the disclosure, the axial angle adjusting unit 140 is a component to solve the misalignment the axial angle of the nozzle moving unit 100 from the axial angle of the nozzle receiving unit 200. According to the disclosure, the axis aligning unit 344 is to correct the horizontal distance between the axis of the nozzle moving unit 100 and the axis of the nozzle receiving unit 200.

According the fluid supply apparatus for the centrifuge of the disclosure, the worker does not personally supply the fluid, but the fluid supply apparatus may supply the fluid into the chamber in the centrifuge, during the centrifugal separation process. Accordingly, the full automation of the centrifugal separation process may be realized, thereby improving the repeatability and the precision of the centrifugal separation process.

In addition, according to the disclosure, the process of collecting and dividing the specific ingredient, such as the blood plasma or the PBMC, of the blood through the pipette to treat a reagent for the specific ingredient may be omitted by using the fluid supply apparatus for the centrifuge. Therefore, in the state, in which ingredients are divided at layers in the chamber, is maintained, the reagent may be treated with respect to only the specific layer.

Further, according to the fluid supply apparatus for the centrifuge of the disclosure, the structure to adjust the position of the nozzle, which supplies the fluid, may be ensured to prepare for when the fluid is failed to be smoothly supplied due to the structural error, thereby ensuring the precision in supplying the fluid.

Further, according to the fluid supply apparatus for the centrifuge of the disclosure, the effective structure to automatically supply the fluid into the chamber of the centrifuge from the outside may be produced, thereby not only completely automating the centrifugal separation process, but rapidly supplying the fluid.

Although embodiments of the disclosure have been described in detail for the illustrative purpose, but the disclosure is not limited thereto. The disclosure may be variously modified and altered by those skilled in the art to which the disclosure pertains without departing from the spirit and scope of the disclosure claimed in the following claims. The protection right for which the disclosure seeks will be apparent from claims attached thereto.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A fluid supply apparatus for a centrifuge, which supplies a fluid to a centrifuge chamber of the centrifuge, the fluid supply apparatus comprising:
a nozzle unit configured to supply the fluid;
a nozzle moving unit movable between an inside or an outside of the centrifuge;
a nozzle receiving unit configured to supply the fluid to the centrifuge chamber by seating the nozzle moving unit; and
a fixing unit coupled to the nozzle moving unit such that the nozzle moving unit is movable, and fixed to the centrifuge.

2. The apparatus of claim 1, wherein the nozzle moving unit includes:
a seating unit having a central portion, through which the nozzle unit passes in an axial direction of the nozzle moving unit, and making contact with the nozzle receiving unit, when the nozzle moving unit is seated in the nozzle receiving unit;
a sliding unit coupled to the nozzle unit to slide in the axial direction on the seating unit and to move the nozzle unit; and
an axial angle adjusting unit coupled to the sliding unit to adjust an axial angle, which is formed in the axial direction, of the nozzle moving unit, when the nozzle moving unit is introduced into the nozzle receiving unit.

3. The apparatus of claim 2, wherein the axial angle adjusting unit includes:
a disk having an annular shape, including a central hole, through which the sliding unit passes and a plurality of through holes, and fixedly coupled to the fixing unit;
a plurality of first shafts, each shaft having one end fixedly coupled to the sliding unit and an opposite end coupled to the thorough hole to slide or to be inclined; and
an axial angle adjusting elastic unit to apply elasticity to the disk and the sliding unit while surrounding the first shaft.

4. The apparatus of claim 3, wherein the sliding unit includes:
a first sidewall having an inner surface formed to slide along an outer surface of the seating unit;
a first inner space formed inside the first sidewall, wherein the seating unit is disposed in the first inner space in one direction of the axial direction;
a first upper wall formed at an opposite end of the first sidewall in the axial direction, wherein the nozzle unit passes through a center of the first upper wall and is fixedly coupled to the center of the first upper wall; and
a flange having an annular shape and fixedly coupled to the plurality of first shafts while extending in a radiation direction from the first sidewall.

5. The apparatus of claim 2, wherein the seating unit includes:
a second sidewall formed to allow the first sidewall to slide;
a seating surface extending in one direction of the axial direction from the second sidewall to make contact with the nozzle receiving unit; and
a second inner space to allow the nozzle unit to pass through the seating unit.

6. The apparatus of claim 5, wherein the nozzle receiving unit includes:
a receiving surface formed in a shape corresponding to a shape of the seating surface to make contact with the seating surface;
an injection hole into which the nozzle unit of the nozzle moving unit seated on the receiving surface, is able to be introduced; and
a first valve unit to be open or closed to supply a fluid from the nozzle unit introduced into an injection hole or to cut off the supply of the fluid from the nozzle unit introduced into the injection hole.

7. The apparatus of claim 6, wherein the first valve unit includes:
a ball to open or close the injection hole; and
a valve elastic structure to apply force to the ball toward the injection hole, and
wherein the sliding unit moves in the one direction of the axial direction such that the nozzle unit pushes the ball in the one direction of the axial direction to allow the first valve unit to be open.

8. The apparatus of claim 3, wherein the fixing unit includes:
a base fixed to a vessel of the centrifuge;
a support structure fixed to the base while extending upward from the base;
a second shaft interposed between an upper end of the support structure and the base; and
an intermediate structure sliding on the second shaft to move the nozzle moving unit.

9. The apparatus of claim 8, wherein the intermediate structure includes:
a first frame slidably coupled to the second shaft to move the nozzle moving unit in a first direction;
a first tube coupled to the nozzle unit to supply the fluid to the nozzle unit from the outside;
a second frame coupled to the disk and open in one side of the second frame such that the first tube passes through the one side of the second frame; and
an axis aligning unit coupled between the first frame and the second frame to move the nozzle moving unit in a second direction perpendicular to the first direction, such that the nozzle moving unit is aligned in line with an axis of the nozzle receiving unit.

10. The apparatus of claim 9, wherein the axis aligning unit include:
a third frame coupled to the first frame and having a sliding groove; and
a fourth frame coupled to the second frame to slide in the second direction in the sliding groove.
